(19) United States
(12) Patent Application Publication
(10) Pub. No.: US 2009/0281794 A1
(43) Pub. Date: Nov. 12, 2009

(54) METHOD AND SYSTEM FOR ORDERING A GIFT WITH A PERSONALIZED CELEBRITY AUDIBLE MESSAGE

(76) Inventors: Sagi Avraham BEN-HAROUSH, Kibbutz Hannita (IL); Dor STOPPER, Kefar Sava (IL)

Correspondence Address: Pearl Cohen Zedek Latzer, LLP, 1500 Broadway, 12th Floor, New York, NY, 10036, US

(21) Appl. No.: 12/116,281

(22) Filed: May 7, 2008

(51) Int. Cl. G10L 19/00

(52) U.S. Cl. 704/201

(57) ABSTRACT

A method for providing a gift with a personalized celebrity message is disclosed. The method includes providing a database of prerecorded audio celebrity messages; offering a customer to select a celebrity message from the database of prerecorded audio celebrity messages; offering the customer to produce a personalized audio message; combining the personalized audio message with the celebrity message into an incorporated audio message; saving the incorporated audio message on a storage medium incorporated with a playback device; and coupling the playback device with the saved incorporated audio message with a gift.

### FIELD OF THE INVENTION

The present invention generally relates to ordering personalized merchandise. More particularly it relates to ordering gift objects with personalized celebrity audible messages.

### BACKGROUND OF THE INVENTION

Greeting cards and other gift objects that play music or recorded voice messages when opened or activated are in wide use. For example, British patent no. GB2408965 (Howard et al.) proposes a variation of the idea where the card is designed to look like a mobile phone, and where the message is recorded by a celebrity impersonator. Belgian patent no. BE1011890 (Greco) discusses a greeting card that has built-in voice recording and playback capability for a sender to record personal messages up to 40 seconds long.

Remote recording of messages to be played back to an intended recipient have also been discussed. In Japanese patent No. JP63207256 (Ikemoto et al.), one wishing to send a message (prayer) to a celebrant telephones an operator and selects a message for the celebrant. Upon telephoning the operator and providing identifying information, the celebrant hears the message played. In U.S. Pat. No. 5,251,251 (Barber et al.) a subscriber records a personalized voice message at a central facility via a telecommunications network. The subscriber also selects a prerecorded message from a library of messages, including messages prerecorded by celebrities or professional celebrity impersonators. The recipient of the messages is mailed a card containing an access code. The recipient telephones the central facility, enters the access code and hears the personalized and subscriber-selected messages played out in succession.

US Patent Application Publication No. 2007/0028264 (Lowe) discusses the distribution of personalized media messages. Audio clips that were recorded or selected for a particular recipient are spliced into a master clip at predefined points, with undetectable transitions between the spliced clips. The personalized message is distributed to the recipient over a device that is linked to a distribution system. The contents of the master clips and insert clips may use celebrity voices or the voices of celebrity impersonators. US Patent Application Publication No. 2003/028377 discusses manipulating specific celebrity voice types into synthesized messages that sound as if they were recorded by the celebrity.

Finally, U.S. Pat. No. 5,444,767 (Goetcheus et al.) describes the recording and delivering of personalized audio messages on playback devices such as greeting cards. A customer remotely records or selects a message at a central facility via a telecommunications channel. The message is digitized and stored, for later transfer to a storefront facility where the message is programmed into the playback device.

It is an object of the invention to provide system and method for remotely ordering a product and personalizing that product with a celebrity audible personalized message that enable a customer to remotely create a personalized audio message by adding personalizing audio content to an audio message that was previously recorded by a celebrity.

Other advantages and objectives of the present invention will become apparent after reading the present specification and reviewing the appended drawings.

### SUMMARY OF THE INVENTION

There is thus provided, in accordance with some embodiments of the present invention, a method for providing a gift with a personalized celebrity message, the method comprising:

providing a database of prerecorded audio celebrity messages;

offering a customer to select a celebrity message from the database of prerecorded audio celebrity messages;

offering the customer to produce a personalized audio message;

combining the personalized audio message with the celebrity message into an incorporated audio message;

saving the incorporated audio message on a storage medium incorporated with a playback device; and

coupling the playback device with the saved incorporated audio message with a gift.

Furthermore, in accordance with embodiments of the present invention, the method further comprises facilitating editing of the incorporated audio message.

Furthermore, in accordance with embodiments of the present invention, the editing includes facilitating dividing the celebrity audio message or the personalized audio message into audio segments and determining an order of the audio segments in the incorporated audio message.

Furthermore, in accordance with embodiments of the present invention, the method further comprises offering the customer to hear the incorporated message before the step of saving the incorporated message.

Furthermore, in accordance with embodiments of the present invention, the personalized audio message is recorded by the customer using a microphone.

Furthermore, in accordance with embodiments of the present invention, the personalized audio message is inputted by the customer using an alphanumeric input device and converted from text to speech.

Furthermore, in accordance with embodiments of the present invention, the gift is selected by the customer from a list of offered gifts.

Furthermore, in accordance with embodiments of the present invention, the steps of offering the customer to select the celebrity message from the database of prerecorded audio celebrity messages and offering the customer to produce a personalized audio message are performed on a terminal.

Furthermore, in accordance with embodiments of the present invention, the steps of combining the personalized audio message with the celebrity message into an incorporated audio message and saving the incorporated audio message on a storage medium incorporated with a playback device are done on a server connected through a communication link to the terminal.

Furthermore, in accordance with embodiments of the present invention, the communication link comprises a network.

Furthermore, in accordance with embodiments of the present invention, the network comprises the Internet.

Furthermore, in accordance with embodiments of the present invention, the method further comprises delivering the gift with the celebrity personalized message to a recipient indicated by the customer.

### BRIEF DESCRIPTION OF THE DRAWINGS

In order to better understand the present invention, and appreciate its practical applications, the following Figures are provided and referenced hereafter. It should be noted that the Figures are given as examples only and in no way limit the scope of the invention. Like components are denoted by like reference numerals.

FIG. 1 is a block diagram of a system for remotely ordering a product and personalizing that product with an audible personalized message according to an embodiment of the present invention.

FIG. 2 is a flow chart of a method for remotely ordering a product and personalizing that product with an audible personalized message according to an embodiment of the present invention.

### DETAILED DESCRIPTION OF EMBODIMENTS OF THE INVENTION

According to embodiments of the present invention a system and a method are provided that enable a customer to select an audible message that was recorded by a celebrity, to modify the recorded message by personalizing it for an intended recipient, and order a product that incorporates the personalized audible message.

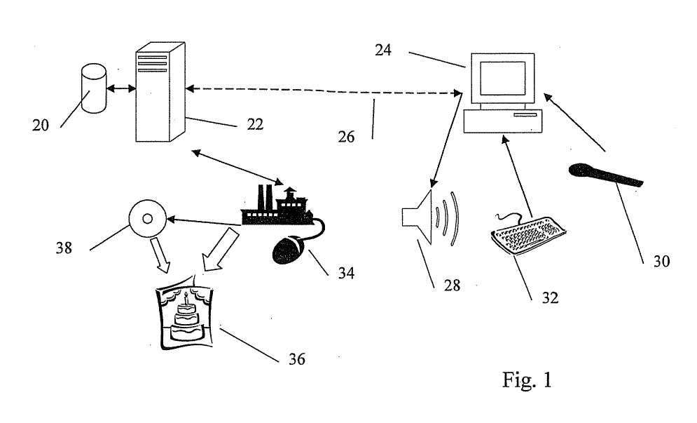

FIG. 1 is a block diagram of a system for remotely ordering a product and personalizing that product with an audible personalized message according to an embodiment of the present invention. Main components are shown. A provider maintains a collection of prerecorded audio messages that were made by celebrities. The messages are stored in the form of audio data files on storage medium 20. The stored files are accessed via provider computer, or provider computer system, 22. Provider computer 22 is in communication with production facility 34. Production facility 34 provides a product 36. Production facility also provides a recordable audio medium 38. At production facility 34, personalized audio content provided by provider computer 22 is recorded on recordable audio medium 38. Product 36 includes means for holding and playing recordable audio medium 38. At production facility 34, recordable audio medium 38 is inserted into product 36. Alternatively, recordable audio medium 38 is built into product 36, and communication is provided via which audio content may be recorded on recordable audio medium 38.

A customer who wishes to order a product with a personalized celebrity audio message operates computer terminal 24. Terminal 24 communicates with provider computer 22 via a communications channel, such as, for example, an intranet, network connection like over the Internet and other communication links. The communications channel may be an Internet connection, a network connection, or any other form of communication between remotely located computers. Terminal 24 is provided with audio input device 30, such as a microphone, for enabling the input of audio content. Terminal 24 is also provided with an alphanumeric input device 32, such as a keyboard, for enabling the input of text data. Terminal 24 is further provided with an audio output device 28, such as a loudspeaker or headphones, for enabling audible output of audio content.

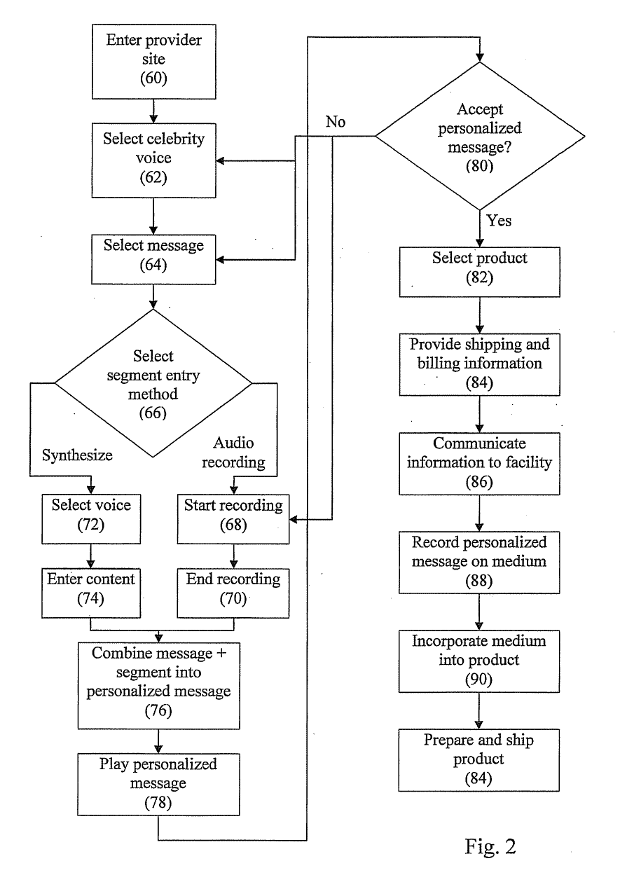

FIG. 2 is a flow chart of a method for remotely ordering a product and personalizing that product with an audible personalized message according to an embodiment of the present invention. The flow chart illustrates main steps in the process of providing a product item incorporating a personalized celebrity message according to embodiments of the present invention. Although the steps in FIG. 2 and in the description below present the steps in a particular order, it should be understood that the order of carrying out some of the steps could be changed without affecting the results of the illustrated process. Therefore, the particular order of the steps should not be construed as limiting the scope of the present invention. It should also be understood that the division of the process into discrete steps, as well as the allocation of activities to the discrete steps, is for the purpose of exposition only, and should not be construed as limiting the scope of the present invention. The following description makes reference to steps illustrated in FIG. 2, and to components shown in FIG. 1.

A customer who wishes to purchase a product with a personalized audible message runs Internet browser or other software on terminal 24 to access Internet connection 26. By means of network connection 26 (over network 25), the customer accesses an Internet site operated by the provider (step 60). By accessing the Internet site, terminal 24 may communicate with provider computer 22. The provider site then presents the customer with a series of graphical user interface (GUI) displays on terminal 24. Each GUI presents the customer with one or more options, and with means to select from among the options. The customer operates terminal 24 to select from among the presented options.

Once the customer has indicated an interest in purchasing a product with a personalized audible message, the provider site may first present a GUI that displays a selection of celebrity voices. The customer selects from among the celebrity voices (step 62). The provider site then presents a GUI that displays a selection of prerecorded messages in the selected celebrity voice. The customer selects from among the messages (step 64).

A selected message may now be personalized by inserting one or more personalizing audio segments into the selected celebrity message or otherwise incorporating between the personalized audio segment(s) and the selected celebrity message. In case of choosing a celebrity message for incorporation with the personalized segment the consumer then chose where to insert the personalized segment. The provider site then presents a GUI with a selection of means for creating a personalizing segment (step 66). Such means may include audio recording of a segment or an audio segment incorporating text to speech, synthesized or recorded human voice segment. “Text to speech” (TTS) technology is known and may include producing from a written text an audio message that can be a synthesized message or a message made up of human voice sampling. An option may also be provided for selection of personalizing segments from among a selection of prerecorded segments. Such a selection of prerecorded segments may be limited to audio segments whose audio content is likely to have wide application, such as commonly found names, common occasions, and similar content.

If the customer selects an option of audio recording a segment, a GUI appears with appropriate screen controls for controlling the recording process. Screen controls may include a RECORD control and a STOP control. When a RECORD control is selected (step 68), audio content is input at terminal 24 via audio input device 30. The audio input is communicated to the provider site and to computer 22. An visible indication may be displayed at terminal 24 indicating that audio input is being recorded. When the STOP control is selected (step 70), audio input is no longer communicated to the provider site or to computer 22. Audio content that was communicated to the provider site between selection of a RECORD control and selection of a STOP control is stored in a temporary audio data file. In some cases, the communication of audio input may be terminated at the initiative of the provider site upon the elapse of a predetermined time interval, or upon the size of the audio content attaining a predetermined value.

If the customer indicates selection of an option of TTS, a GUI appears that enables entering properties and content of the TTS segment. The GUI may include presentation of a selection of voice styles for the TTS segment. The customer indicates selection of a voice style (step 72). Content of the segment may be entered as text using text input device 32 (step 74). When all data needed to create a segment are entered, the entered data is communicated to the provider site and to computer 22. TTS software associated with computer 22 creates audio content based on the entered data. The created audio content is stored in a temporary audio data file.

Upon completion of selection of a celebrity message and of creation of a personalizing segment, computer 22 manipulates the data files that containing the personalizing segment and the celebrity message. The result of the manipulation is a single personalized message where a personalizing segment is inserted into the prerecorded celebrity message (step 76). The personalized message is stored in the form of a temporary audio data file. A GUI then appears with screen controls that enable the playing of the personalized message. Such controls may include a PLAY control and a STOP control. Selecting a PLAY control causes the audio data file containing the personalized message to be audibly played by audio output device 28 (step 78). Selecting a STOP control causes audio output device to stop playing the audio data file. The GUT also includes controls for accepting the personalized message or for rejecting and remaking the personalized message. The customer selects from among the options (step 80).

If the customer indicates non-acceptance of the personalized message, a GUI from one of previous steps 62 to 74 is redisplayed. In some embodiments of the present invention, the customer is presented with the option of backspacing through the previously presented GUIs until the desired GUI appears. Alternatively, screen controls presented at step 80 enable the customer to indicate directly which of the previous GUIs is to be redisplayed.

If the customer indicates acceptance of the personalized message, computer 22 stores the personalized message on data storage device 20. A GUI appears that presents the customer with a selection of products into which the personalized message may be incorporated. The customer selects from among the selection (step 82). Further GUIs appear that prompt the customer to enter additional information. Such additional information may include shipping information, billing information, and content of a text message to be included with the selected product (step 84). All entered information, including the selection of a product, is communicated to the provider site and to computer 22. Computer 22 stores the information on data storage device 20 in such a manner that the information is associated with the personalized message file.

Upon successful completion of communication with the customer, all required information, including the personalized data file, is available to computer 22. At an appropriate time, perhaps after confirmation of billing information, computer 22 communicates all necessary information to facility 34 (step 86). Information communicated to facility 34 may include the content of the personalized message, product selection, and shipping information. Facility 34 records the personalized message on medium 38 (step 88), which includes, for example, medium for storing the incorporated message as well as hardware to play it, such as, for example, an electronic board and a loudspeaker. Facility 34 or another supplier provides product item 36. Then item 38 is coupled to product 36 (step 90). Facility 34 or another facility then prepares product 36 item for shipping and ships product item 36. When a recipient of product item 36 performs a predetermined action, such as, for example, opening a card or pressing a button, the audio means inserted in product item 36 audibly plays the incorporated personalized message.

The following is a more detailed description of some of the above steps for implementing embodiments of the present invention. Where indicated, reference is made to components shown in FIG. 1 and to process steps illustrated in FIG. 2.

In accordance with embodiments of the present invention, voices of celebrities reciting various messages are prerecorded. The celebrity messages are stored as audio data files on data storage device 20 that communicates with computer system 22 that is operated by a provider.

Celebrities may include individuals or groups of individual whose voices are familiar to a population or populations. Celebrities may also include voice impersonators, cartoon voice characters and other celebrated characters whose voices are familiar to a population or populations.

In step 62, the customer is presented with a selection of celebrity voices. Each item of the selection represents a collection of files containing messages by a particular celebrity voice. A celebrity voice from the selection may be represented by any form suitable for representing an item available for selection, including, but not limited to, text, an icon, a photograph, or by a combination of two or more such forms. The customer may indicate a selection by any suitable means, including, but not limited to, clicking or double-clicking on a representation, a check box, a screen button, or a radio button.

In step 64, the customer is presented with selection of celebrity messages that were recorded by the selected celebrity voice. Each item of the selection represents an audio data file containing a celebrity message that was recorded by the selected celebrity voice. Each item available for selection may be represented by: a title of the celebrity message, a text of the message content, or an abbreviated form of the text. A representation may include an indication of predetermined points of the celebrity message where personalizing audio segments may be inserted or appended. Such predetermined points may be indicated, for example, by blank spaces or underlined blank spaces in a text of the celebrity message. The representation may indicate any limitations on the duration of the personalizing segments that may be inserted or appended. The representation may also include appropriate screen controls that allow the customer to listen to the celebrity message played on audio output device 28 associated with customer terminal 24. The customer may indicate a selection by any suitable means, including, but not limited to, clicking or double-clicking on a representation, a check box, a screen button, or a radio button.

As indicated by steps 66 through 76, a selected celebrity message may be personalized by the insertion of a personalizing audio segment. A personalizing segment may comprise an audio recording or a TTS audio data. The content of a personalizing audio segment may include personalizing information such as a personal name, an occasion, a relationship, a date, etc or a full sentence or paragraph recorded by the customer. The result of the insertion of a personalizing segment in the celebrity message is a single personalized message. The personalized message comprises both the celebrity message and the personalizing segment. In general, the desired result is a personalized message audio file that when played on an audio output device, such as the audio means in product item 38, the audible output would sound as if the entire personalized message, including the personalizing segment, were recited by the celebrity voice or as a message from the sender with the celebrity participating in to form the incorporated message.

In embodiments of the present invention, the customer is presented with an option to TTS a personalizing segment as in steps 72 and 74. Computer 22 runs text-to-speech software to create the personalizing segment. The customer enters text that defines the audio content of the personalizing segment. The text-to-speech program uses the entered text to create an audio signal. When this audio signal is played on an audio output device, the audible output sounds like the text being read aloud. The text that the customer enters is such as to cause the creation of audible output that sounds to the customer like the desired personalizing segment. The nature of the entered text may depend on the characteristics of the software and on the language of the content of the desired personalizing segment. In some cases, the entered text may include a written version of a desired personalizing segment in standard spelling. In other cases, the entered text may include phonetic spelling of a desired personalizing segment.

In general, text-to-speech software often creates speech by concatenating pieces of sampled recorded speech. The resulting then would sound as if it were spoken by the person whose speech was recorded and sampled. Such speech may be described as having a specific voice style. A customer selecting to TTS a personalizing segment may be presented with a selection of voice styles. The selection of styles that is presented may include a voice style based closely matching that of the celebrity voice that was selected in step 62. Such a voice style may be based on sampled recorded speech spoken by the selected celebrity, or spoken by an impersonator of the selected celebrity. Selection of such a closely matching voice style may result in a personalizing segment that sounds as if it was spoken by the selected celebrity.

The method of insertion of a personalizing audio segment into a prerecorded celebrity audio message, in accordance with embodiments of the present invention, is now discussed with reference to an example. A prerecorded audible message with has content: “Hi, happy birthday.” The message is stored in digital form as a sequence of bits. The comma after the word “hi” represents a pause in the audible content. A created personalizing audio segment, “John,” is also stored in digital form as a sequence of bits. The personalizing segment “John” is to be inserted in the message between the word “hi” and the word “happy.” The desired resulting personalized message should sound like a single personalized message: “Hi John, happy birthday.”

In order to insert the personalizing segment into the message, the digital representation of the message is divided into two segments. The first segment represents the message segment: “hi.” The second segment represents the message segment: “, happy birthday.” The comma before the word happy represents a pause in the audible content. The desired personalized message is now created by concatenating the digital representations of the segments. The order of the concatenated segments is as follows: first message segment, personalizing segment, second message segment. These digital segments represent the audible content: “hi” “John” “, happy birthday.” The concatenated message then has the desired content: “Hi John, happy birthday.”

In embodiments of the present invention, insertion of a personalizing segment may be limited to predetermined points of a prerecorded celebrity message. Predetermined points may be selected as appropriate to the content of the recorded message. For example, should the recorded message be, “Happy birthday from me, David Beckham,” a personalizing segment may be added to the beginning or the end of the message. In this case, the context would suggest that the content of the personalizing segment include an additional message in the form of a sentence or sentence fragment. In that case the personalized message will be a combination of the user and the celeb together greeting the recipient. In another example, “Hi (RECIPIENT NAME), happy birthday from me, David Beckham,” the personalizing segment may be inserted after the word “hi,” replacing the RECIPIENT NAME. In this case, the context would suggest that the content of the personalizing segment include a name or nickname of an intended recipient. Alternatively, a point of a prerecorded message for insertion of a personalizing segment may be freely selected by the customer.

In some embodiments of the invention, more than one personalizing segments may be inserted in a prerecorded celebrity message. In this case, the procedures of steps 66 through 80 for creation and insertion of a personalizing segment would be repeated for each segment.

In some embodiments of the invention, the duration of a personalizing segment may be limited to a maximum duration. Alternatively, the duration of a personalizing segment may be unlimited, or limited only by memory space considerations.

It should be clear that the description of the embodiments and attached Figures set forth in this specification serves only for a better understanding of the invention, without limiting its scope.

It should also be clear that a person skilled in the art, after reading the present specification could make adjustments or amendments to the attached Figures and above described embodiments that would still be covered by the present invention.

What is claimed is:

1. A method for providing a gift with a personalized celebrity message, the method comprising:
providing a database of prerecorded audio celebrity messages;
offering a customer to select a celebrity message from the database of prerecorded audio celebrity messages;
offering the customer to produce a personalized audio message;
combining the personalized audio message with the celebrity message into an incorporated audio message;
saving the incorporated audio message on a storage medium incorporated with a playback device; and
coupling the playback device with the saved incorporated audio message with a gift.

2. The method as claimed in claim 1, further comprising facilitating editing of the incorporated audio message.

3. The method as claimed in claim 2, wherein the editing includes facilitating dividing the celebrity audio message or the personalized audio message into audio segments and determining an order of the audio segments in the incorporated audio message.

4. The method as claimed in claim 1, further comprising offering the customer to hear the incorporated message before the step of saving the incorporated message.

5. The method as claimed in claim 1, wherein the personalized audio message is recorded by the customer using a microphone.

6. The method as claimed in claim 1, wherein the personalized audio message is inputted by the customer using an alphanumeric input device and converted from text to speech.

7. The method as claimed in claim 1, wherein the gift is selected by the customer from a list of offered gifts.

8. The method as claimed in claim 1, wherein the steps of offering the customer to select the celebrity message from the database of prerecorded audio celebrity messages and offering the customer to produce a personalized audio message are performed on a terminal.

9. The method as claimed in claim 8, wherein the steps of combining the personalized audio message with the celebrity message into an incorporated audio message and saving the incorporated audio message on a storage medium incorporated with a playback device are done on a server connected through a communication link to the terminal.

10. The method as claimed in claim 9, wherein the communication link comprises a network.

11. The method as claimed in claim 10, wherein the network comprises the Internet.

12. The method as claimed in claim 1, further comprising delivering the gift with the celebrity personalized message to a recipient indicated by the customer.
